(19) United States
(12) Patent Application Publication
(10) Pub. No.: US 2022/0213375 A1
(43) Pub. Date: Jul. 7, 2022

(54) SPENT JET-ENGINE OIL AS DRILLING LUBRICANT

(71) Applicant: Saudi Arabian Oil Company, Dhahran (SA)

(72) Inventors: Isa Al-Umairin, Dammam (SA); Md Amanullah, Dhahran (SA); Abrar Alshaikh, Saihat (SA); Ali Radhwan, Dhahran (SA)

(73) Assignee: Saudi Arabian Oil Company, Dhahran (SA)

(21) Appl. No.: 17/140,237

(22) Filed: Jan. 4, 2021

(51) Int. Cl. C09K 8/28; C09K 8/20; C09K 8/16; C09K 8/14

(52) U.S. Cl. CPC C09K 8/28; C09K 8/206; C09K 2208/34; C09K 8/145; C09K 8/16

(57) ABSTRACT

A water-based drilling fluid having spent jet-engine oil as a lubricant. A system and method for utilizing the spent jet-engine oil and the water-based drilling fluid to drill a borehole in a subterranean formation in the Earth crust.

### TECHNICAL FIELD

This disclosure relates to utilizing spent jet-engine oil as a lubricant for drilling applications.

### BACKGROUND

Drilling fluid aides the drilling of holes into a subterranean formation in the Earth crust. The holes may be labeled as a borehole or a wellbore. The drilling fluid may be called drilling mud. The hole may be drilled for the exploration or production of crude oil and natural gas. The hole may be drilled for other applications, such as a water well. During the drilling, the drilling fluid may cool and lubricate the drill bit and also carry and remove rock cuttings from the hole. The drilling fluid may provide hydrostatic pressure to prevent or reduce formation fluids from the subterranean formation entering into the hole during drilling.

### SUMMARY

An aspect relates to a method of drilling a borehole in a subterranean formation, including operating a drill bit to drill the borehole in the subterranean formation, pumping a water-based drilling fluid having water and lubricant that is spent jet-engine oil through the drill bit in the borehole, and reducing friction via the lubricant in operation of the drill bit to drill the borehole.

Another aspect relates to a method of drilling a borehole in a subterranean formation, including drilling the borehole in the subterranean formation via a drill bit, circulating a water-based drilling fluid having water and lubricant that is spent jet-engine oil through the drill bit in the borehole and as return to an Earth surface from the borehole, reducing friction via the lubricant in the drilling of the borehole.

Yet another aspect relates to a method of utilizing a spent jet-engine oil, including obtaining spent-jet engine oil collected from an aircraft jet engine, wherein the spent jet-engine oil includes jet engine oil from the aircraft jet engine after operation of the aircraft jet engine with the jet engine oil. The method includes processing the spent jet-engine oil to give a processed spent jet-engine oil, wherein the processing includes separating solids from the spent jet-engine oil. The method includes adding the processed spent jet-engine oil to a water-based drilling fluid.

Yet another aspect relates to a water-based drilling fluid having at least water, viscosifier, soda ash, and lubricant. The soda ash includes sodium bicarbonate. The lubricant includes spent jet-engine oil.

The details of one or more implementations are set forth in the accompanying drawings and the description below. Other features and advantages will be apparent from the description and drawings, and from the claims.

### BRIEF DESCRIPTION OF DRAWINGS

FIG. 1 is a block diagram depicting a processing system that treats spent jet-engine oil to give processed spent jet-engine oil for addition to water-based drilling fluids.

FIG. 2 is a block flow diagram of a method of utilizing a spent jet-engine oil.

FIG. 3 is a diagram of a drill site, which may be a location for oil exploration and production activities.

FIG. 4 is a diagram of the laboratory system utilized to process the spent jet-engine oil for the Examples.

FIG. 5 is a bar chart of percent (%) reduction in coefficient of friction (COF) in the Examples for the four water-based mud systems after addition of the spent jet-engine oil.

### DETAILED DESCRIPTION

Some aspects of the present disclosure are directed to applications of waste aviation oil including spent jet-engine oil. The techniques may utilize spent jet-engine oil for drilling applications as a lubricant product for different types of water-based mud systems. Lubricants may be added to water-based mud systems to provide lubricity. Embodiments include water-based mud systems incorporating spent jet-engine oil as a lubricant that reduces the coefficient of friction (COF) in drilling. Described below are examples of water-based mud systems incorporating spent jet-engine oil as a lubricant that reduces the COF in drilling. Water-based mud systems may also be called water-based drilling fluids, water-based drilling fluid systems, water-based mud, water-based drilling mud, and water-based drilling mud systems.

The techniques may include processing waste jet-engine oils for addition to water-based mud systems to improve the lubricating potential of water-based mud systems. For some implementations that utilize spent jet-engine oil (waste jet-engine oil) as a lubricant in water-based mud systems, the spent jet-engine oil may be processed before addition of the spent jet-engine oil to the drilling fluid. In those implementations, the spent jet-engine oil incorporated into the drilling fluid may be labeled as treated spent jet-engine oil or processed spent jet-engine oil. An example of treatment or processing is to remove solid particles from the spent jet-engine oil. The spent jet-engine oil may have particles (e.g., contaminant particles) introduced into the jet engine oil during operation of the jet engine and/or subsequently during collection of the spent jet-engine oil. The particles may include colloidal and non-colloidal particles. The particles may be unwanted particles.

Drilling fluid (mud) is generally an integral part of drilling operations. Drilling fluid can be important in rotary drilling, casing while drilling, underbalance drilling, overbalance drilling, etc. Drilling fluid may be utilized complete several functional tasks and facilitate a more trouble-free and economical drilling operation. One objective of drilling mud is typically the reduction of friction. For instance, the drilling fluid may reduce friction between the drill string and the casing by acting as a lubricating medium at the metal-metal interface. The drilling fluid may reduce friction between the drill string and the borehole wall by acting as a lubricating medium at the metal-mudcake interface while drilling. Conventional water-based drilling muds may have poor lubricating properties and thus give higher COF compared to oil-based or synthetic oil-based muds. This can be a disadvantage of water-based mud compared to oil-based mud systems.

High COF can cause various drilling problems, such as reduction in drilling efficiency, increase in equipment wear and pipe twist-off, reduction in the rate of penetration (ROP), and increase the torque and drag. In case of horizontal and extended reach wells, high COF can be particularly problematic. High COF can limit the reach of horizontal and extended reach wells and thus could be a barrier for extended reach drilling operation. Drilling fluids with low COF values may be desirable for horizontal and extended reach drilling operations. Different types of lubricating additives can be included in water-based mud systems to reduce the COF and mitigate torque and drag.

Reduction of frictional resistance via the COF values associated with water-based muds by incorporating lubricating additives in the drilling fluid system is a fluid design strategy. Lubricating materials employed in water-based mud formulations to enhance the lubricating properties of water-based muds are diesel oil, mineral oil, synthetic oil, detergents, bentonite clays, alcohols, gilsonite, asphaltic materials, cellulosic materials, polymers, dextrose, glycerin, amines etc. These lubricants may have limited capacity to reduce the COF of drilling mud to enhance the fluid performance and can be relatively expensive (high cost). Some of the lubricating materials may have poor stability with respect to low temperature and/or high temperature and thus prone to thermo-chemical degradation in certain drilling environments. Moreover, for some regions of the world, conventional lubricants are not produced locally and thus are imported. Cost of imported lubricants can significantly increase mud cost.

Embodiments herein with water-based mud lubricant as spent jet-engine oil may provide for development of the lubricant locally where spent jet-engine oil is available. Spent jet-engine oil may be a locally available material. In implementations, spent jet-engine oil as lubricant can reduce the lubricant cost, add new lubricant in the current lubricant bank, reduce dependency on imported lubricant, and play a role in the localization of water-based mud lubricant development.

The present techniques may utilize spent jet-engine oil as lubricant to enhance the lubricating potential of different types of water-based mud systems. As mentioned, the spent jet-engine oil added to the water-based mud system may be processed or treated spent jet-engine oil.

In implementations, the water-based mud system including water and the spent jet-engine oil (as lubricant) may additionally include at least one of a viscosifier (e.g., clay, bentonite, polysaccharide, xanthan gum, XC polymer), fluid loss additive (e.g., polyanionic cellulose polymer or PAC LV™), monovalent salt (e.g., potassium chloride), divalent salt (e.g., calcium chloride), soda ash, filler (e.g., Rev Dust™), shale inhibition additive (e.g., Soltex®), and thermal stability agent (e.g., sodium sulfite). Certain viscosifiers, such as clays or bentonite, can also act a lubricant or have a lubricating effect. Also, in some implementations, the filler can be a friction-reducing material.

Again, the present techniques may utilize spent jet-engine oil as lubricant to enhance the lubricating potential of water-based mud systems. Jet engine oil is synthetic oil and generally stable at high temperatures (e.g., 0° C.) and low temperatures (e.g., 150° C.). In implementations, a majority weight percent of the jet engine oil as synthetic oil may be esters and can include polyol esters. Among jet engine oils, there can be variation of thermal characteristics and chemical composition and thus the functional behavior. Spent jet engine oil may have contaminants incorporated during the operational period of the jet engine, such as micro-sized metal particles, carbon, varnish, and gum. The amount and type of contaminants may depend on how long-term the use of the oil and the time-dependent degradation of the oil. In certain instances, the solid particles as contaminants in the spent jet-engine oil may include particles that contaminated the spent jet-engine oil during the subsequent collection of the spent jet-engine oil from the aircraft jet engine. As mentioned, the spent jet-engine oil may be processed to remove at least some of the solid particles before incorporation of the spent jet-engine oil into water-based mud systems.

In the Examples below, the lubricating performance of the processed spent jet-engine oil to reduce the COF was evaluated in different water-based mud systems as compared to the base muds. See Table 2. For example, the spent jet-engine oil was evaluated in bentonite mud (clay-based mud system) to consider the lubrication effect of spent jet-engine oil on clay-based mud systems. The spent jet-engine oil was included in KCl-polymer mud having the monovalent potassium-chloride (KCl) to evaluate the effect of monovalent salts on the lubricant performance of spent jet-engine oil. The spent jet-engine oil was included in CaCl₂)-polymer mud having the divalent calcium-chloride (CaCl₂)) to evaluate the effect of a divalent salt environment on the lubricant performance of spent jet-engine oil. The spent jet-engine oil as lubricant was also evaluated in a low-solids non-dispersed (LSND) mud.

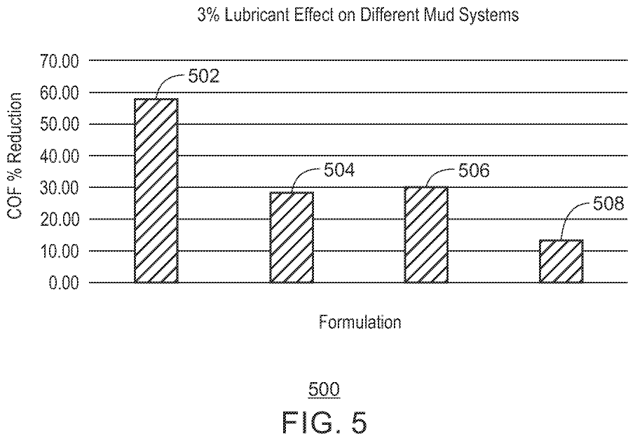

In order to test the lubricating effect of the processed spent jet-engine oil in the Examples, the base muds were loaded with 3 volume percent (vol %) of the processed spent jet-engine oil. Initially, the base muds were tested without the processed spent jet-engine oil in the mud systems. Then, the mud systems were loaded with 3 vol % of the processed spent jet-engine oil to determine the lubrication effect of the spent oil on the different water-based mud systems. The results show variable lubricating effect among the different mud systems. In the Examples, the spent jet-engine oil showed lubricating action in clay-based bentonite mud, which can be due to the creation of a slippery action on the clays. See FIG. 5. The spent jet-engine oil showed moderate lubrication effect with monovalent and divalent salt based muds, and low lubrication effect on LSND mud systems. Results of the evaluations in the Examples are presented below.

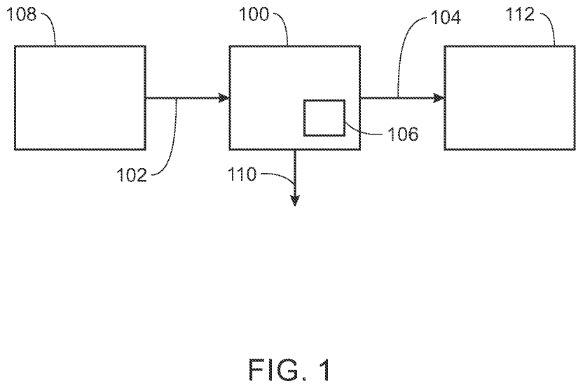

FIG. 1 depicts a processing system 100 that treats spent jet-engine oil 102 to give processed spent jet-engine oil 104 for addition to water-based drilling fluids. The processing system 100 includes at least one vessel 106. The processing system 100 receives the spent jet-engine oil 102 from a source 108 of the spent jet-engine oil 102. The source 108 may include a vessel holding the spent jet-engine oil 102. The processing or treatment via the system 100 may include to add chemicals or other additives to the jet-engine oil 102.

In some implementations, the processing via the system 100 includes to remove solid particles 110 from the spent jet-engine oil 102. For instance, the vessel 106 may be a separator vessel that removes the solid particles 110 from the spent jet-engine oil 102. The separator vessel can be, for example, a filter as a filter housing having a filter element that removes the solid particles 110 from the spent jet-engine oil 102. The separator vessel can be, for example, a centrifuge, solid bowl centrifuge, decanter centrifuge, and the like. The separator vessel can be, for example, a settling vessel that holds the spent jet-engine oil 102 for a given time and with the solid particles settling to a bottom portion of the separator vessel. The settled solid particles 110 may discharge from the bottom portion of the separator vessel.

The solid particles 110 may include colloidal and non-colloidal particles. The vessel 106 may include two separator vessels operationally in series in which one separator vessel removes primarily non-colloidal particles from the spent jet-engine oil 102 and the other separator vessel removes primarily colloidal particles from the spent jet-engine oil 102.

The processed spent jet-engine oil 104 may be provided to a destination 112. The destination 112 can include a vessel that receives the processed spent jet-engine oil 104. The destination 112 may receive the processed spent jet-engine oil 104 for distribution to users. The destination 112 may add the processed spent jet-engine oil 102 to a water-based drilling fluid.

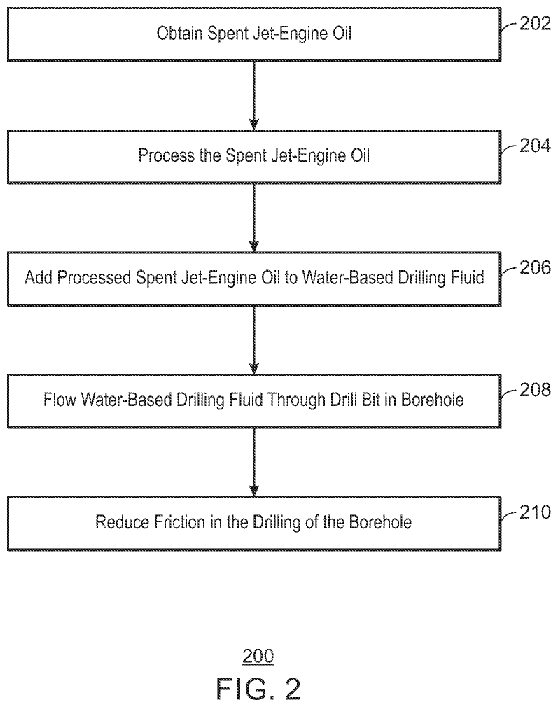

FIG. 2 is a method 200 of utilizing a spent jet-engine oil. At block 202, the method includes obtaining spent jet-engine oil collected from an aircraft jet engine. The spent jet-engine oil is jet engine oil from the aircraft jet engine after operation of the aircraft jet engine with the jet engine oil.

At block 204, the method includes processing the spent jet-engine oil to give a processed spent jet-engine oil. The processing includes separating solids from the spent jet-engine oil. The separating may include at least one of settling (the solids), decanting, filtering, centrifuging, and so on. The solids separated from the spent jet-engine oil may include colloidal particles. Colloidal particles may have a particle size, for example, in a range of 1 nanometer (nm) to 1,000 nm. The solids separated from the spent jet-engine oil may include non-colloidal particles.

At block 206, the method includes adding the processed spent jet-engine oil to a water-based drilling fluid. The water-based drilling fluid may include primarily water on both a volume basis and weight basis. The processed spent jet-engine oil is added as a lubricant additive to the water-based drilling fluid. The processed spent jet-engine oil in the water-based drilling fluid may be, for example, in a range of 1 vol % to 6 vol % based on the volume of water in the water-based drilling fluid. The water-based drilling fluid may have soda ash, bentonite, and other components.

At block 208, the method may include drilling a borehole in a subterranean formation via a drill bit. In implementations, the drill bit is rotated to drill the borehole. The method can include flowing (e.g., pumping, circulating, etc.) the water-based drilling fluid having the processed spent jet-engine oil through the drill bit in the borehole and as return to an Earth surface.

At block 210, the method can include reducing friction in the drilling of the borehole. The friction can be reduced via the processed spent jet-engine oil in the drilling fluid. For example, the friction and COF between the drill string and the borehole wall can be reduced via the processed spent jet-engine oil. The drill bit may be coupled to the drill string. The friction and COF between the drill string and a casing in the borehole can be reduced via the processed spent jet-engine oil.

Table 1 gives four implementations of water-based drilling fluid having spent jet-engine oil as lubricant. The first water-drilling fluid is labeled as bentonite mud. The second water-drilling fluid is labeled as KCl-polymer mud. The third water-based drilling fluid is labeled as CaCl₂)-polymer mud. The fourth water-based drilling fluid is labeled as an inhibitive low-solids non-dispersed (LSND) mud. Other water-based drilling fluids not given in Table 1 but having the spent jet-engine oil as lubricant are applicable. The spent jet-engine oil may be processed jet-engine oil, such as processed to remove solid particles from the spent jet-engine oil. In Table 1, numerical ranges are given for components of the water-based drilling fluids in units of milliliters (ml) or grams (g). The volume of the water is a reference basis with respect to the remaining components for the given water-based drilling fluid.

TABLE 1
Water-Based Drilling Fluids

| | Bentonite | KCl-Polymer | CaCl₂-Polymer | LSND |
|---|---|---|---|---|
| Components | Mud | Mud | Mud | Mud |
| Water (ml) | 270-410 | 260-400 | 260-400 | 260-400 |
| Spent Jet-Engine | 5-15 | 5-15 | 5-15 | 5-15 |
| Oil (ml) | | | | |
| Soda Ash (g) | <1 | <1 | <1 | <1 |
| Bentonite (g) | 5-50 | 2-10 | 2-10 | 3-12 |
| PAC LV (g) | — | 1-6 | 1-6 | 1-6 |
| XC Polymer (g) | — | <4 | <4 | <4 |
| KCl (g) | — | 5-40 | 5-40 | 5-40 |
| CaCl₂ (g) | — | — | 10-45 | — |
| Rev Dust (g) | — | — | 5-50 | — |
| Soltex (g) | — | — | — | 1-7 |
| Sodium Sulfite (g) | — | — | — | 0.2-3 |

Soda ash is the common name for sodium carbonate (Na₂CO₃) and is a weak base soluble in water, and dissociates into sodium (Na) and carbonate (CO₃) ions in solution. The soda ash may be included in drilling fluid, for example, to reduce the water hardness of the drilling fluid. Bentonite is a clay, such as aluminium phyllosilicate clay consisting mostly of montmorillonite. PAC LV™ is a fluid loss additive that is a low-molecular weight polyanionic cellulose polymer. PAC LV™ is available from AMC Drilling Optimisation of Balcatta, Western Australia, Australia. Other fluid loss additives are applicable. XC polymer is a polysaccharide also known as xanthan gum. XC polymer may generally have the molecular formula C₃₆H₅₈O₂₉P₂. Other polymers or polysaccharides are applicable. Bentonite and XC polymer may each be a viscosifier. Other viscosifiers are applicable. The KCl is potassium chloride as monovalent salt. Other monovalent salts are applicable. The CaCl₂) is calcium chloride as divalent salt. Other divalent salts are applicable. Rev Dust™ is very small particles (finely ground altered calcium montmorillonite clay) that can be a filler, filler solids, or filler phase, and can be a friction-reducing material. Rev Dust™ is trademarked by Milwhite, Inc. located in Brownsville, Tex. USA.

Soltex® is a shale inhibitor (shale inhibition additive) that is a sodium asphalt sulfonate soluble in water and available from Chevron Phillips Chemical Company, LLC having headquarters in The Woodlands, Tex. USA. Other shale inhibitors or shale inhibition additives are applicable. The KCl may act as a shale inhibitor or shale inhibition agent. Shale inhibitors or shale inhibition additives are generally mud conditioners that work to stabilize shale formations. Shale inhibitors may stabilize shale sections and improve filtercake characteristics. In some implementations, sulfonated-asphalt shale inhibitors may be a free-flowing powder and can be added directly to the water-based drilling fluid. Lastly, sodium sulfite may be for thermal stability. Other temperature stabilizers or thermal stability agents are applicable. Thermal stability agents (temperature stabilizers) may provide for thermal stability of the drilling fluid up to temperatures of 120° C. or 150° C., or greater. Thermal stability agents may provide for thermal stability of components and rheology of the water-based drilling fluid. Some thermal stability agents may increase the thermal stability of the rheological parameters of drilling fluids, such as apparent viscosity, plastic viscosity, yield point, and gel strength.

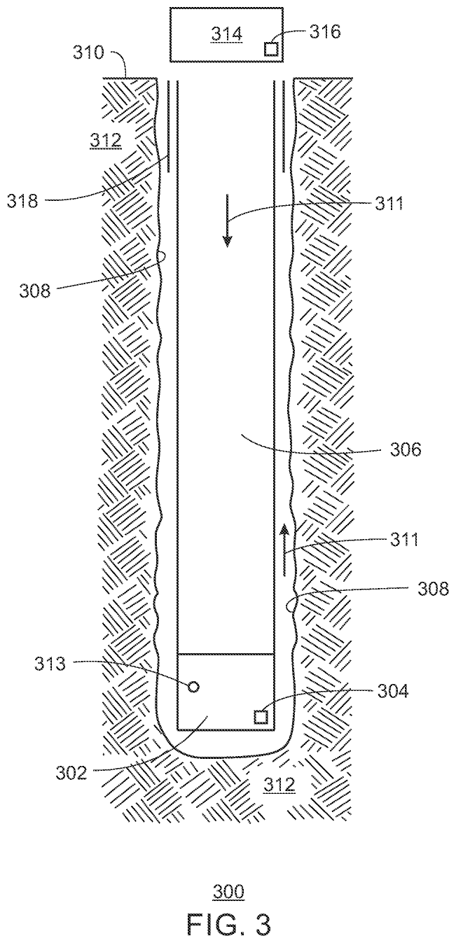

FIG. 3 is a drill site 300 which may be a location for oil exploration and production activities. The drilling operation may employ a drilling fluid 311 that is a water-based drilling fluid having spent jet-engine oil (e.g., processed spent jet-engine oil) as a lubricant additive. The drill site 300 may be on-shore or an off-shore platform, and the like. Well drilling or borehole drilling may form a hole in the ground for the extraction or exploration of a natural resource such as ground water, brine, natural gas, petroleum, metallic ore, and so on. The drilling to form the hole can be for the injection of a fluid from surface to a subsurface reservoir, or for subsurface formations evaluation or monitoring, and so forth. The drill site 300 may be a workplace and equipment to drill an oil or gas well and establish associated infrastructure such as a wellhead platform. The drill site 300 may include a mounted drilling rig, pipeline, and storage tanks, and arrange for transport of crude oil and natural gas to processing facilities.

To form a hole in the ground, a drill bit 302 having multiple cutters 304 may be lowered into the hole being drilled. In operation for some implementations, the drill bit 302 may rotate to break the rock formations to form the hole. In the rotation, the cutters 304 may interface with the ground or formation to grind, cut, scrape, shear, crush, or fracture rock to drill the hole. A drill bit may also be referred to as a rock bit or simply a bit, and the like. In examples, the drill bit 302 may be a fixed cutter bit or a hybrid bit that combines both rolling cutter elements and fixed cutter elements (cutters 304). In the illustrated example, only one cutter 304 of the multiple cutters is depicted for clarity.

The drill bit 302 may be a component of a drill string 306 or coupled to the drill string 306. The drill bit 302 may be lowered via the drill string 306 into the hole (borehole also called a wellbore 308) to drill the wellbore 308. The wellbore 308 as a hole or borehole in the ground may be formed through an Earth surface 310 into a subterranean formation 312 in the Earth crust. In operation, a water-based drilling fluid 311 (also known as water-based drilling mud) having spent jet-engine oil is circulated down the drill string 306 and through nozzles 313 of the drill bit 302 to the bottom of the wellbore 308. The drilling fluid 311 may then flow upward toward the surface 310 through an annulus between the drill string 306 and the wall of the wellbore 308. The drilling fluid may cool the drill bit 302, apply hydrostatic pressure upon the formation penetrated by the wellbore 308 to prevent or reduce fluids from flowing into the wellbore 308, reduce torque and drag between the drill string 306 and the wellbore 308, carry the formation cuttings (rock cuttings) to the surface 310, and so forth. The drill bit 302 typically has more than one nozzle 313.

The return drilling fluid 311 may be processed by the surface equipment 114 to remove rock cuttings from the drilling fluid 311. The drilling fluid 311 may be pumped into the drill string 306 by mud pump(s) 316 of the surface equipment 314. The mud pumps 315 may be positive displacement pumps (e.g., reciprocating pumps) or centrifugal pumps. The drilling fluid 311 may be circulated through the drill bit 302 and as return up the wellbore 308 in the annulus between the drill string 306 and wellbore 308 wall, and then processed by surface equipment 314 to remove rock cuttings (and additional treatment) and pumped back down the drill string 306 through the drill bit 302. The wellbore 308 may have cased portions, as indicated by the casing 318. The casing 318 may be cemented. In other words, cement may be disposed between the outer diameter of the casing 318 and the formation 312 openhole surface.

The spent jet-engine oil in the drilling fluid 311 may address torque or drag of the drill string 308 (drill pipe). The spent jet-engine oil in the drilling fluid 311 may reduce friction and COF between the drill string 308 (drill pipe) and the casing 318 in cased portions of the wellbore 108. The spent jet-engine oil in the drilling fluid 311 may reduce friction and COF between the drill string 308 and the formation 312 surface defining the wellbore 308 wall in openhole portions of the wellbore 308.

A drill string 306 on a drilling rig may be a column or string of drill pipe that transports drilling fluid pumped from mud pumps 316 to the drill bit 302. In addition, the drill string 306 may transmit torque via a drive to the drill bit 302. In certain examples, the drill string 306 may be the assembled collection of drill pipe, drill collars, tools, and the drill bit 302, and the like. A plurality of drill pipe couple end-to-end, such as via tool joints, may make up the majority of the drill string 306 to the surface 310. In implementations, each drill pipe may be a relatively long tubular section having a specified outside diameter or nominal diameter, such as 3½ inches, 4 inches, 5 inches, 5½ inches, 5⅞ inches, 6⅝ inches, and so forth.

In certain embodiments, the drill string 306 includes the drill pipe as well as a bottom hole assembly (BHA) and transition pipe which maybe heavyweight drill pipe (HWDP). The BHA may include the drill bit 302, drill collars which may be relatively heavy tubes to apply weight to the drill bit 302, and drilling stabilizers which maintain the assembly centered in the hole. The BHA may also include a downhole motor and rotary steerable system, measurement while drilling (MWD) tools, and logging while drilling (LWD) tools, and the like. The components of the drill string 306 may be joined together via threaded connections or other connections.

The drill string 306 may be hollow so that drilling fluid 311 can be pumped through the drill bit 302 and ejected through nozzles 313 of the drill bit 302. As mentioned, the drilling fluid 311 may be circulated back up an annulus, such as between the drill string 306 and the openhole or casing 318. Rolling cutter and fixed cutter drill bits may have internal passages to direct drilling fluid 311 through hydraulic nozzles 313 directed at the bottom of the wellbore 308 to produce high-velocity fluid jets. These jets may assist in cleaning rock cuttings off the bottom before the next contact of the drill bit 302 with the rock. Again, the drilling fluid 311 may be conveyed to the drill bit 302 by the drill pipe from surface pumps 316. The circulating drilling fluid 311 may provide buoyancy to the drill string 306, lubricate the drilling, cool equipment, remove cuttings from the wellbore 308, and so forth.

The drill site 300 typically has a drilling rig including equipment discussed above and includes surface equipment 314 such as tanks, pits, pumps, and piping for circulating drilling fluid 311 (mud) through the wellbore 308. Settling equipment or a separation vessel, such as a shale shaker, may receive a slurry of the drilling fluid 311 and rock cuttings from the wellbore 308. The shale shaker may separate rock cuttings from the drilling fluid. Pits may collect removed rock cuttings. The drilling rig or surface equipment 314 may include a derrick, Kelly drive, top drive, rotary table, drill floor, blowout preventer (BOP), and additional equipment, components, or features. A mobile laboratory onsite may test the drilling fluid 311 or rock cuttings. Temporary housing may be provided at the drill site 300 for operating personnel, and the like.

In general, a drilling rig is a machine that creates holes in the Earth subsurface. The term “rig” may refer to equipment employed to penetrate the surface of the Earth crust. Oil and natural gas drilling rigs create holes to identify geologic reservoirs and that allow for the extraction of oil or natural gas from those reservoirs.

The hole or wellbore 308 diameter produced by a drill bit 302 may be in a range from about 3.5 inches (8.9 centimeters) to 30 inches (76 centimeters), or outside of this range. The depth of the hole 308 can range from 1,000 feet (300 meters) to more than 30,000 feet (9,100 meters). Subsurface formations are broken apart mechanically by cutting elements 304 of the bit 302 by scraping, grinding, localized compressive fracturing, and so on. As indicated, the cuttings produced by the bit 302 are typically removed from the wellbore 308 and returned to the surface 310, for example, via direct circulation. The return may be continuous, substantially continuous, or intermittent. The drilling operation performance may be evaluated based on at least rate of penetration (ROP).

An embodiment is a method of drilling a borehole in a subterranean formation. The borehole may also be called a wellbore. The method includes operating a drill bit to drill the borehole in the subterranean formation. Operating the drill bit may include lowering the drill bit from an Earth surface via a drill string into the borehole. Operating the drill bit may include rotating the drill bit to drill the borehole. The method includes pumping a water-based drilling fluid having water and lubricant that is spent jet-engine oil through the drill bit in the borehole. The spent jet-engine oil may be jet engine oil collected from an aircraft jet engine after operation of the aircraft jet engine with the jet engine oil. The method may include obtaining the spent jet-engine oil as collected and adding the spent jet-engine oil to the water-based drilling fluid. The spent jet-engine oil may be spent jet-engine oil processed to remove solids from the spent jet-engine oil. The water-based drilling may be pump from the Earth surface into the drill string and through the drill string and drill bit, and as a discharge from the drill bit at a bottom portion of the borehole. The drilling fluid may return up through the borehole external to the drill string (drill pipe) to the Earth surface. Thus, the pumping of the water-based drilling fluid through the drill bit may include discharging the water-based drilling fluid from the drill bit as return to the Earth surface. The method may include removing subterranean-formation rock cuttings from the borehole via the circulating water-based drilling fluid. The method includes reducing friction via the lubricant in operation of the drill bit to drill the borehole, such as reducing friction between the drill string and the wall of the borehole or between the drill string and casing installed in the borehole.

Another embodiment is a method of drilling a borehole in a subterranean formation. The method includes drilling the borehole in the subterranean formation via a drill bit. The borehole may have a borehole wall (subterranean formation surface) defined by the drill bit in drilling the borehole in the subterranean formation. The drill bit may be coupled to a drill string. The method includes circulating a water-based drilling fluid having water and lubricant that is spent jet-engine oil through the drill bit in the borehole and as return to the Earth surface from the borehole. The drilling fluid may be circulated through the drill string and drill bit from the Earth surface. The method includes reducing friction via the lubricant in the drilling of the borehole, such as reducing COF between the drill string and the wall of the borehole or reducing COF between the drill string and casing installed in the borehole.

Yet another embodiment is a water-based drilling fluid having water, viscosifier, soda ash, and lubricant. The soda ash includes sodium bicarbonate. The lubricant includes spent jet-engine oil. The viscosifier may be clay, bentonite, or polysaccharide, or any combinations thereof. The water-based drilling fluid may include a fluid loss additive (e.g., a cellulose polymer) and a monovalent salt (e.g., KCl). The water-based drilling fluid may additionally include divalent salt (e.g., CaCl₂)) and filler solids (e.g., calcium montmorillonite clay). The water-based drilling fluid may additionally include a shale inhibition additive (shale inhibitor) (e.g., sodium asphalt sulfonate) and a thermal stability agent (temperature stabilizer) (e.g., sodium sulfite).

Described below are Examples of water-based mud systems incorporating spent jet engine oil as a lubricant giving percent reduction in COF. In the Examples, different water-based mud systems having spent jet engine oil as a lubricant are compared with respect to the base mud.

### Examples

Jet engine oil utilized in operation of an aircraft jet engine was obtained as collected from the jet engine as spent jet-engine oil for the Examples. The jet engine oil was Mobil Jet Oil II available from ExxonMobil Chemical Company having headquarters in Houston, Tex. USA. Mobil Jet Oil II meets approval by the US military specification MIL-PRF-23699-STD also identified as NATO Code Number O-156. Mobil Jet Oil II is synthetic oil that is primarily synthetic esters and has additives. Mobil Jet Oil II is stable synthetic base oil and a chemical additive package including anti-oxidant, metal deactivator, corrosion inhibitor, pour point depressant, and thermal stability enhancer. Mobil Jet Oil II has: (a) autogenous ignition temperature of 404° C. per 30 CFR § 35.20 (7-1-12 Edition); (b) density at 15° C. of 1.0035 kilograms per liter (kg/I) per ASTM D4052-18a; and (c) pour point of −89° C. per ASTM D5950-14 (2020).

The spent jet-engine oil was processed to remove solids. For utilizing spent jet-engine oil (waste jet-engine oil) as a lubricant for water-based mud systems, the spent jet-engine oil was processed before addition of the spent jet-engine oil to the drilling fluid. In the particular processing for the Examples, the collected spent jet-engine oil was kept in static condition for more than 24 hours to settle non-colloidal particles and contaminants associated with the collection process. The top part (upper portion) of the spent jet engine oil was decanted and then filtrated using a 5 micron hardened filter paper at a low pressure differential of 10 pounds per square inch (psi) across the filter paper to remove unwanted colloidal and sub-colloidal particles and impurities. The spent jet-engine oil after this filtering may be labeled as processed spent jet-engine oil and was utilized as a lubricant in water-based drilling fluids (water-based drilling muds) in the Examples.

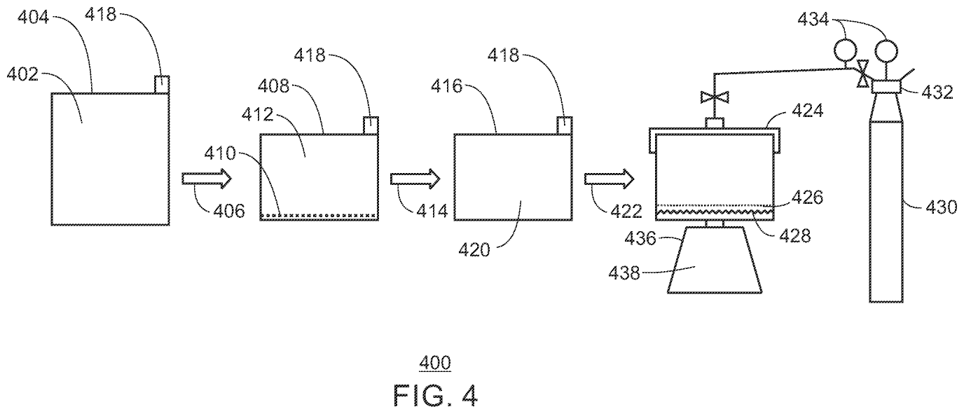

FIG. 4 is the laboratory system 400 utilized to process the spent jet-engine oil for the Examples. Spent jet-engine oil 402 was held as collected in a holding container 404 and transferred 406 to a container 408. In the container 408 as a separator container, the spent jet-engine oil 402 was subjected to static aging for non-colloidal particle sedimentation. In particular, the spent jet-engine oil was kept in static condition for more than 24 hours to settle (by gravity) non-colloidal particles to a bottom portion of the container 408. The settled particles 410 at the bottom portion of the container generally included non-colloidal particles.

The remainder of the spent jet-engine oil (the top phase 412) above the settled particles 410 was decanted (manually poured 414) into a clean container 416. The three containers 404, 408, and 416 each had a port 418 that can be used as an inlet port, outlet port, or vent. The port 418 can be used to fill the container, or to pour/decant from the container. The top phase 412 poured from the previous container 408 is labeled as the decanted top phase 420 in the container 416. In some embodiments on the bulk scale, this separation can be implemented by draining out the cloudy bottom layer (having settled particles) from the clear top layer in a static aging unit of certain processing systems.

In the laboratory for the Examples, the decanted top phase 420 was placed 422 into a filtration cell 424 for low-pressure filtration for colloidal particles removal. The filtration cell 424 included filter paper 426 and a metallic screen 428 disposed below the filter paper 426. The filter paper 426 was a 5-micron hardened filter paper. The metallic screen 428 was a 250 microns screen made of steel wires. The laboratory system 400 included a pressure cylinder 430 having compressed air. A pressure regulator 432 included a regulating valve. Two pressure gauges 434 were disposed on each side of the regulating valve, respectively.

In operation, a pressure of 10 pounds per square inch gauge (psig) was applied to the filtration cell 424 via the compressed-air pressure cylinder 430. The applied pressure gave a pressure differential of approximately 10 psi across the combined arrangement of the filter paper 426 and metallic screen 428. Clean spent jet-engine oil discharged from the filtration cell 424 into a collector container 436. The clean spent jet-engine oil 438 in the collector container 436 may be labeled as treated, filtered, or processed spent jet-engine oil and was utilized in the Examples.

The water-based mud systems in the Examples were the four different water-based mud systems shown in Table 2. The water-based mud systems may also be called water-based drilling fluid or water-based drilling fluid systems. In Table 2, the amount of water is given in milliliters (ml). The remaining components are given in grams (g).

The first water-based mud system is labeled as bentonite mud. As bentonite is a clay (aluminium phyllosilicate clay consisting mostly of montmorillonite), the bentonite mud was used to evaluate the lubrication effect of spent jet-engine oil in a clay-based mud system. The second water-based mud system is labeled as KCl-polymer mud. The KCl-polymer mud included potassium chloride (KCl) as monovalent salt. The KCl-polymer mud was used to evaluate the effect of monovalent salt on the lubricant performance of the spent jet-engine oil. The third water-based mud system is labeled as CaCl₂)-polymer mud. The CaCl₂)-polymer mud included calcium chloride (CaCl₂)) as a divalent salt. The CaCl₂)-polymer mud was used to evaluate the performance of the spent jet-engine oil as lubricant in a divalent salt environment. Lastly, the fourth water-based mud system is labeled as LSND mud. The LSND mud included KCl and Soltex® for shale inhibition and sodium sulfite for thermal stability. As mentioned, Soltex® is a sodium asphalt sulfonate that is water soluble. Bentonite and XC polymer are each a viscosifier. As discussed, XC polymer is a polysaccharide (also known as xanthan gum) and PAC LV™ is a fluid loss additive that is a polyanionic cellulose polymer. Rev Dust™ is finely ground calcium montmorillonite clay that can be filler solids.

TABLE 2
Mud systems to evaluate performance of spent
jet-engine oil as lubricant

| | Bentonite | KCl-Polymer | CaCl₂-Polymer | LSND |
|---|---|---|---|---|
| Mud Components | Mud | Mud | Mud | Mud |
| Water (ml) | 340.67 | 332 | 332 | 332 |
| Soda Ash (g) | 0.25 | 0.25 | 0.25 | 0.30 |
| Bentonite (g) | 25 | 5 | 5 | 6 |
| PAC LV (g) | — | 3 | 3 | 3 |
| XC Polymer (g) | — | 1 | 1 | 1 |
| KCl (g) | — | 20 | 20 | 20 |
| CaCl₂ (g) | — | — | 20 | — |
| Rev Dust (g) | — | — | 25 | — |
| Soltex (g) | — | — | — | 3 |
| Sodium Sulfite (g) | — | — | — | 1 |

The lubricating performance of the spent jet-engine oil (the processed spent jet-engine oil 438 as discussed with respect to FIG. 4) was evaluated. Initially, the four water-base muds without the spent jet-engine oil were tested with a lubricity testers. The lubricity tester was the OFITE lubricity tester, which is an industry-standard lubricity tester that is a standard apparatus in the oil and gas industry. The OFITE lubricity tester is available from OH Testing Equipment, Inc. (OFITE) having headquarters in Houston, Tex., USA.

In order to test the lubricating effect of this spent jet-engine oil as processed, the spent jet-engine oil was added to each of the four water-based muds (four water-based mud systems) in Table 2. The spent jet-engine oil was added to each of the four formulations at 3 vol % of the water in the mud (mud system). Thus, about 10.22 ml of the spent jet-engine oil was added to the bentonite mud and about 9.96 ml of the spent jet-engine oil was added to the remaining three muds. Each of the four muds having the 3 vol % of spent jet-engine oil was tested with the lubricity tester to determine the lubricating effect of the spent oil on these water-based mud systems. Based on the lubricity tester results for the muds having the spent jet-engine oil as compared to the lubricity tester results for the muds without the spent jet-engine oil, the percent reduction in COF was determined.

FIG. 5 is a bar chart 500 of percent (%) reduction in COF for the four water-based mud systems after adding the spent jet-engine oil in the Examples. The percent reduction in COF was determined based on the test results with the lubricity tester. The bar 502 is for the bentonite mud, which is a clay-based mud system because bentonite is clay, and which gave about 58% reduction in COF with addition of the spent jet-engine oil as compared to the bentonite mud without the spent jet-engine oil. The bar 504 is for the KCl-polymer mud, which gave about 28% reduction in COF with the addition of the spent jet-engine oil as compared to the KCl-polymer mud without the spent jet-engine oil. The bar 506 is for the CaCl₂)-polymer mud, which experienced about a 30% reduction in COF with the addition of the spent jet-engine oil as compared to the CaCl₂)-polymer mud without the spent jet-engine oil. The bar 508 is for the LSND mud, which experienced about a 12% reduction in COF with the addition of the spent jet-engine oil as compared to the LSND mud without the spent jet-engine oil.

Thus, the results show variable lubricating effect of the spent jet-engine oil among the four water-based mud systems having different composition. As depicted, the spent jet-engine oil in the Examples is most effective for the clay-based mud system 502. Such may be due to the effective lubrication of clay surfaces and clay-based mud at the metal-metal interface. The presence of the spent jet-engine oil had a moderate lubricating effect in the water-based mud 504 having monovalent salt (KCl) and the water-based mud 506 having divalent salt (CaCl₂)). The presence of the spent jet-engine oil had a lower effect with the inhibitive LSND mud system 508 having KCl and Soltex.

In view of the Examples, the spent jet-engine oil is an applicable lubricant for the four water-based systems, such as to reduce the torque and drag of the drill string (drill pipe). For these specific Examples, the spent jet-engine oil was most beneficial for the bentonite mud of these given four muds, and thus beneficial generally for clay-based mud systems. In particular, the presence of the spent jet-engine oil may address clay sticking to drill pipe, stabilizers, reamers, and drill bits. By virtue of the improvement of slippery nature of clay surfaces, the spent jet-engine oil as lubricant may play a role in reducing the bit balling associated with gumbo clays due to the reduction of their sticking tendency to drill bits, and so on.

In conclusion, the techniques may facilitate to reduce COF associated with water-based muds, with significant effects in implementations of clay-based mud systems and polymer mud systems (monovalent salt environment and divalent salt environment), and with modest effect on LSND mud. Hence, the techniques may increase drill bit life, reduce wear and tear of downhole tools, and increase ROP. Moreover, the utilization of spent jet-engine oil as drilling fluid lubricant may contribute to the localization of lubricant development by employing locally-available spent jet-engine oil as feedstock. Lastly, by virtue of the significant lubricating effect of spent jet-engine oil in implementations of clay-based systems, the presence of the spent jet-engine oil as lubricant may reduce the clay sticking tendency to stabilizers, reamers, and drill bits. Thus, the spent jet-engine oil can be expected in implementations to reduce the bit balling tendency in gumbo and swelling clays, and the like.

A number of implementations have been described. Nevertheless, it will be understood that various modifications may be made without departing from the spirit and scope of the disclosure.

1. A method of drilling a borehole in a subterranean formation, comprising:
receiving spent jet-engine oil that is jet engine oil from an aircraft jet engine after operation of the aircraft jet engine with the jet engine oil, wherein the jet engine oil comprises primarily synthetic esters;
processing the spent jet-engine oil to give a processed spent jet-engine oil, wherein the processing comprises separating solids from the spent jet-engine oil;
operating a drill bit to drill the borehole in the subterranean formation;
pumping a water-based drilling fluid comprising water and lubricant through the drill bit in the borehole, wherein the lubricant comprises the processed spent jet-engine oil; and
reducing friction via the lubricant in operation of the drill bit to drill the borehole.

2. The method of claim 1, comprising removing subterranean-formation rock cuttings from the borehole via the water-based drilling fluid, wherein the processing comprising separating solids from the spent jet-engine oil comprises settling the solids, decanting, filtering, or centrifuging, or any combinations thereof, and wherein reducing friction in the operation of the drill bit comprises reducing friction between a drill string and a wall of the borehole.

3. The method of claim 1, wherein the separating solids from the spent jet-engine oil comprises:
maintaining the spent jet-engine oil static in a vessel, thereby settling particles in the spent jet-engine oil to a bottom portion of the vessel;
removing the spent jet-engine oil from the vessel without the particles that settled; and
filtering the spent-engine oil as removed from the vessel to remove additional particles to give the processed spent jet-engine oil, and wherein reducing friction in the operation of the drill bit comprises reducing friction between a drill string and casing installed in the borehole.

4. The method of claim 1, wherein pumping the water-based drilling fluid through the drill bit comprises discharging the water-based drilling fluid from the drill bit, and wherein separating solids from the spent jet-engine oil comprises removing solids comprising primarily non-colloidal particles from the spent jet-engine oil via a first separator vessel and removing solids comprising primarily colloidal particles from the spent jet-engine oil via a second separator vessel.

5. The method of claim 1, comprising adding the processed spent jet-engine oil to the water-based drilling fluid comprising bentonite drilling mud comprising bentonite and soda ash, wherein the bentonite drilling mud comprises at least 0.073 gram of bentonite per milliliter of water, and wherein operating the drill bit comprises lowering the drill bit into the borehole.

6. A method of drilling a borehole in a subterranean formation, comprising:
receiving spent jet-engine oil that is jet engine oil from an aircraft jet engine after operation of the aircraft jet engine with the jet engine oil, wherein the jet engine oil comprises synthetic oil having a majority weight percent of esters;
processing the spent jet-engine oil to give a processed spent jet-engine oil, wherein the processing comprises separating solids from the spent jet-engine oil;
drilling the borehole in the subterranean formation via a drill bit;
circulating a water-based drilling fluid comprising water and lubricant comprising the processed spent jet-engine oil through the drill bit in the borehole; and
reducing friction via the lubricant in the drilling of the borehole.

7. The method of claim 6, wherein the processing comprising separating solids from the spent jet-engine oil comprises settling the solids, decanting, filtering, or centrifuging, or any combinations thereof, wherein reducing friction in drilling the borehole comprises reducing a coefficient of friction between a drill string and a wall of the borehole, wherein the water-based drilling fluid comprises bentonite drilling mud comprising bentonite and soda ash, and wherein the bentonite drilling mud comprises at least 0.073 gram of bentonite per milliliter of water.

8. The method of claim 6, wherein separating the solids from the spent jet-engine oil comprises:
maintaining the spent jet-engine oil static in a vessel, thereby settling solids in the spent jet-engine oil to a bottom portion of the vessel;
decanting the spent jet-engine oil from the vessel without the solids that settled; and
filtering the spent-engine oil as decanted to remove additional solids to give the processed spent jet-engine oil, wherein reducing friction in drilling the borehole comprises reducing a coefficient of friction between a drill string and casing installed in the borehole.

9. A method of utilizing a spent jet-engine oil, comprising:
obtaining spent jet-engine oil that is jet engine oil from an aircraft jet engine after operation of the aircraft jet engine with the jet engine oil, wherein the jet engine oil comprises primarily synthetic esters;
processing the spent jet-engine oil to give a processed spent jet-engine oil, wherein the processing comprises separating solids from the spent jet-engine oil, wherein the solids separated from the spent jet-engine oil comprise colloidal particles; and
adding the processed spent jet-engine oil as lubricant to a water-based drilling fluid.

10. The method of claim 9, wherein the colloidal particles comprise a particle size in a range of 1 nanometer (nm) to 1,000 nm.

11. The method of claim 9, comprising:
drilling a borehole in a subterranean formation via a drill bit;
circulating the water-based drilling fluid comprising the processed spent jet-engine oil through the drill bit in the borehole; and
reducing friction in the drilling of the borehole via the processed spent jet-engine oil.

12. A water-based drilling fluid comprising water, viscosifier, soda ash, and lubricant, wherein the soda ash comprises sodium bicarbonate, and wherein the lubricant comprises spent jet-engine oil.

13. The water-based drilling fluid of claim 12, wherein the viscosifier comprises clay.

14. The water-based drilling fluid of claim 12, wherein the viscosifier comprises bentonite.

15. The water-based drilling fluid of claim 12, wherein the viscosifier comprises bentonite and a polysaccharide.

17. The water-based drilling fluid of claim 12, comprising a fluid loss additive.

18. The water-based drilling fluid of claim 17, wherein the fluid loss additive comprises a cellulose polymer.

19. The water-based drilling fluid of claim 12, comprising a monovalent salt.

20. The water-based drilling fluid of claim 19, comprising a divalent salt.

21. The water-based drilling fluid of claim 20, comprising filler solids.

22. The water-based drilling fluid of claim 21, wherein the filler solids comprise calcium montmorillonite clay.

23. The water-based drilling fluid of claim 19, comprising a shale inhibition additive.

24. The water-based drilling fluid of claim 23, wherein the shale inhibition additive comprises sodium asphalt sulfonate.

25. The water-based drilling fluid of claim 19, comprising a thermal stability agent.

26. The water-based drilling fluid of claim 25, wherein the thermal stability agent comprises sodium sulfite.
